(19) United States
(12) Patent Application Publication
(10) Pub. No.: US 2024/0141080 A1
(43) Pub. Date: May 2, 2024

(54) OPTICAL RESIN COMPOSITION AND OPTICAL RESIN FORMED BODY

(71) Applicant: NITTO DENKO CORPORATION, Ibaraki-shi, Osaka (JP)

(72) Inventors: Hiromu Tsuchida, Osaka (JP); Takashi Ozaki, Osaka (JP)

(73) Assignee: NITTO DENKO CORPORATION, Ibaraki-shi, Osaka (JP)

(21) Appl. No.: 18/277,123

(22) PCT Filed: Feb. 15, 2022
(86) PCT No.: PCT/JP2022/006019

§ 371 Date: Aug. 14, 2023

(30) Foreign Application Priority Data
Feb. 16, 2021 (JP) 2021-022887

(51) Int. Cl. C08F 124/00; C08L 37/00; G02B 1/04

(52) U.S. Cl. CPC C08F 124/00; C08L 37/00; G02B 1/046; C08L 2201/10

(57) ABSTRACT

An optical resin composition of the present invention includes fluorine-containing resin and a refractive index modifier. The optical resin composition satisfies the following matter (a) or (b): (a) the refractive index modifier includes 95 mass % or more of a linear polymer (A) including repeating units based on a fluorine-containing ethylene-based monomer such that the number of the repeating units is 5, and a proportion of a content of the linear polymer (A) in the optical resin composition is 1 mass % or more and less than 15 mass %; (b) the refractive index modifier includes 95 mass % or more of a linear polymer (B) including repeating units based on a fluorine-containing ethylene-based monomer such that the number of the repeating units is 6, and a proportion of a content of the linear polymer (B) in the optical resin composition is 1 mass % or more and less than 13 mass %.

### TECHNICAL FIELD

The present invention relates to an optical resin composition and an optical resin formed body.

### BACKGROUND ART

A fluorine-containing resin is a useful substance used as a material of optical members such as plastic optical fibers (hereinafter referred to as “POFs”) and exposure members in a wide range of fields. In a case where a fluorine-containing resin is used as a material of an optical member, an optical resin composition obtained by mixing various additives such as a refractive index modifier with the fluorine-containing resin is used in general. For example, when a fluorine-containing resin is used as a core material of a graded-index POF in which refractive indexes of a core are distributed so as to be symmetric with respect to a central axis, a refractive index distribution is formed by diffusing a refractive index modifier in an optical resin composition in which the refractive index modifier is added to the fluorine-containing resin.

The refractive index modifier to be added to the fluorine-containing resin is a compound having a relatively low molecular weight in many cases. Therefore, in a case where the refractive index modifier is mixed with the fluorine-containing resin, a problem with compatibility between the fluorine-containing resin and the refractive index modifier arises, that is, a problem arises that the refractive index modifier is not uniformly mixed with the fluorine-containing resin. Therefore, for example, Patent Literature 1 suggests that at least one kind of a fluorine-containing polycyclic compound selected from perfluoro(1,3,5-triphenylbenzene) and perfluoro(1,2,4-triphenylbenzene) be used as a refractive index modifier to be added to a fluorine-containing resin.

### CITATION LIST

### Patent Literature

Patent Literature 1: JP 4682394B

### SUMMARY OF INVENTION

### Technical Problem

To date, various compounds to be used as the refractive index modifier have been suggested in order to obtain an optical resin composition having improved compatibility between a fluorine-containing resin and the refractive index modifier, as described above. However, a refractive index modifier which has been conventionally suggested has insufficient compatibility with a fluorine-containing resin in an optical resin composition including the fluorine-containing resin and the refractive index modifier. Thus, a problem that, for example, transparency is degraded still arises.

In recent years, an optical member has been required to have high thermal resistance in many cases. Therefore, many of fluorine-containing resins used as materials of optical members have high glass transition temperatures. The optical resin composition that includes a fluorine-containing resin having a high glass transition temperature as described above requires a high temperature in processing. Therefore, the optical resin composition is required to allow a refractive index to be adjusted in a desired range by the refractive index modifier even through such high temperature processing, that is, required to endure high-temperature processing.

Therefore, an object of the present invention is to provide an optical resin composition that includes a fluorine-containing resin and a refractive index modifier, that can be used even in high-temperature processing, and that inhibits degradation of transparency by improved compatibility between the fluorine-containing resin and the refractive index modifier. Another object of the present invention is to provide an optical resin formed body having a refractive index adjusted in a desired range, and having sufficient transparency.

### Solution to Problem

An optical resin composition according to a first aspect of the present invention includes fluorine-containing resin and a refractive index modifier, and the optical resin composition satisfies the following matter (a) or (b):
(a) the refractive index modifier includes 95 mass % or more of a linear polymer (A) including repeating units based on a fluorine-containing ethylene-based monomer such that the number of the repeating units is 5, and a proportion of a content of the linear polymer (A) in the optical resin composition is 1 mass % or more and less than 15 mass %;
(b) the refractive index modifier includes 95 mass % or more of a linear polymer (B) including repeating units based on a fluorine-containing ethylene-based monomer such that the number of the repeating units is 6, and a proportion of a content of the linear polymer (B) in the optical resin composition is 1 mass % or more and less than 13 mass %.

An optical resin formed body according to a second aspect of the present invention includes the optical resin composition according to the first aspect.

### Advantageous Effects of Invention

The present invention can provide an optical resin composition that can be used even in high-temperature processing, and that inhibits degradation of transparency by improved compatibility between the fluorine-containing resin and the refractive index modifier. Furthermore, the present invention can also provide an optical resin formed body having a refractive index adjusted in a desired range, and having sufficient transparency.

### DESCRIPTION OF EMBODIMENTS

### Embodiment 1

An embodiment of an optical resin composition of the present invention will be described. The optical resin composition of the present embodiment includes a fluorine-containing resin and a refractive index modifier. The optical resin composition of the present embodiment satisfies the following matter (a) or (b).
(a) The refractive index modifier includes 95 mass % or more of a linear polymer (A) including repeating units based on a fluorine-containing ethylene-based monomer such that the number of the repeating units is 5, and a proportion of a content of the linear polymer (A) in the optical resin composition of the present embodiment is 1 mass % or more and less than 15 mass %.
(b) The refractive index modifier includes 95 mass % or more of a linear polymer (B) including repeating units based on a fluorine-containing ethylene-based monomer such that the number of the repeating units is 6, and a proportion of a content of the linear polymer (B) in the optical resin composition of the present embodiment is 1 mass % or more and less than 13 mass %.

In a case where the optical resin composition of the present embodiment satisfies the above-described matter (a) or (b), the optical resin composition of the present embodiment can have high transparency by improved compatibility between the fluorine-containing resin and the refractive index modifier, and can be used even in high-temperature processing. In the description herein, the optical resin composition that can be used in high-temperature processing means an optical resin composition that can allow a refractive index of the optical resin composition to be adjusted in a desired range by the refractive index modifier even when processed in high-temperature processing.

What mechanism allows the optical resin composition of the present embodiment to ensure transparency and to also be used in high-temperature processing, by including the linear polymer (A) in the range specified by the matter (a) or the linear polymer (B) in the range specified by the matter (b), is not clear. However, the linear polymer (A) and the linear polymer (B) each have a relatively small number of repeating units, and are thus considered to make a better contribution to improvement of solubility of the refractive index modifier in the fluorine-containing resin. In a case where the optical resin composition of the present embodiment includes the linear polymer (A) in the range specified by the matter (a) or the linear polymer (B) in the range specified by the matter (b), both enhancement of solubility of the refractive index modifier in the fluorine-containing resin, and reduction of volatilization of the refractive index modifier in the case of high-temperature processing being performed are considered to be achieved in a better balanced manner. Therefore, in this configuration, an optical resin composition that can achieve high transparency and, furthermore, can be used even in higher-temperature processing even in a case where, for example, a proportion of a content of the refractive index modifier is increased, is considered to be obtained.

In a case where the optical resin composition of the present embodiment satisfies the matter (a), that is, in a case where the refractive index modifier included in the optical resin composition of the present embodiment contains 95 mass % or more of the linear polymer (A), the content of the linear polymer (A) in the optical resin composition of the present embodiment is 1 mass % or more and less than 15 mass %. In this case, the content of the linear polymer (A) in the optical resin composition of the present embodiment may be, for example, 7 mass % or more, 8 mass % or more, or 9 mass % or more. Meanwhile, the content of the linear polymer (A) in the optical resin composition of the present embodiment may be, for example, 14 mass % or less, 13 mass % or less, 12 mass % or less, or 11 mass % or less. The upper limit and the lower limit of a range of a proportion of the content of the linear polymer (A) in the optical resin composition of the present embodiment may be defined by any combination obtained by selecting from the above-described values. For example, the content of the linear polymer (A) in the optical resin composition according to an embodiment may be 1 mass % or more and 14 mass % or less, may be 8 mass or more and less than 15 mass %, may be 8 mass or more and 14 mass % or less, may be 8 mass or more and 12 mass % or less, or may be 8 mass or more and 11 mass % or less. In a case where the refractive index modifier included in the optical resin composition of the present embodiment contains 95 mass % or more of the linear polymer (A), even when a proportion of the content of the refractive index modifier in the optical resin composition is increased, since the optical resin composition of the present embodiment contains the linear polymer (A) at the proportion in the above-described range, high transparency can be achieved. Furthermore, since a volatilization start temperature of the refractive index modifier can be made high while good solubility of the refractive index modifier in the fluorine-containing resin is maintained, the optical resin composition that can be used even in higher-temperature processing while ensuring transparency, can be obtained. In this case, the volatilization start temperature of the refractive index modifier can be, for example, 200° C. or higher. That is, the optical resin composition of the present embodiment includes the refractive index modifier in the above-described range, and thus, a refractive index can be easily adjusted so as to be in an appropriate range without significantly reducing thermal resistance of the optical resin composition.

In a case where the optical resin composition of the present embodiment satisfies the matter (b), that is, in a case where the refractive index modifier included in the optical resin composition of the present embodiment contains 95 mass % or more of the linear polymer (B), the content of the linear polymer (B) in the optical resin composition of the present embodiment is 1 mass % or more and less than 13 mass %. In this case, the content of the linear polymer (B) in the optical resin composition of the present embodiment may be, for example, 7 mass % or more, 8 mass % or more, 9 mass % or more, or 10 mass % or more. Meanwhile, the content of the linear polymer (B) in the optical resin composition of the present embodiment may be, for example, 12 mass % or less. The upper limit and the lower limit of a range of a proportion of the content of the linear polymer (B) in the optical resin composition of the present embodiment may be defined by any combination obtained by selecting from the above-described values. For example, the content of the linear polymer (B) in the optical resin composition according to an embodiment may be 1 mass % or more and 12 mass % or less, may be 8 mass or more and less than 13 mass %, or may be 8 mass or more and 12 mass % or less. In a case where the refractive index modifier included in the optical resin composition of the present embodiment contains 95 mass % or more of the linear polymer (B), even when a proportion of the content of the refractive index modifier in the optical resin composition is increased, since the optical resin composition of the present embodiment contains the linear polymer (B) at the proportion in the above-described range, high transparency can be achieved. Furthermore, since a volatilization start temperature of the refractive index modifier can be made high while good solubility of the refractive index modifier in the fluorine-containing resin is maintained, the optical resin composition that can be used even in higher-temperature processing while ensuring transparency, can be obtained. In this case, the volatilization start temperature of the refractive index modifier can be, for example, 200° C. or higher. That is, the optical resin composition of the present embodiment includes the refractive index modifier in the above-described range, and thus, a refractive index can be easily adjusted so as to be in an appropriate range without significantly reducing thermal resistance of the optical resin composition.

The linear polymer (A) that includes repeating units based on a fluorine-containing ethylene-based monomer such that the number of the repeating units is 5, and the linear polymer (B) that includes repeating units based on a fluorine-containing ethylene-based monomer such that the number of the repeating units is 6 can each be obtained by, for example, distilling a polymer of the fluorine-containing ethylene-based monomers and isolating a polymer in units of the number of the repeating units. In such a method, the polymer having the target number of repeating units can be obtained at a purity of 95 mol % or higher.

As the fluorine-containing ethylene-based monomers that constitute the linear polymer, for example, a compound represented by the following formula (1) is used.

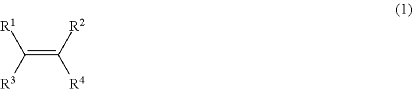

(in the formula (1), R¹ represents a fluorine atom, and R², R³, and R⁴ each independently represent a fluorine atom, a halogen atom, or a hydrogen atom.)

The fluorine-containing ethylene-based monomer is preferably free of a hydrogen atom. The optical resin composition of the present embodiment is used for optical applications. The optical resin composition is desirably free of a C—H bond from the viewpoint of reducing light absorption due to stretching energy of a C—H bond. Therefore, the fluorine-containing ethylene-based monomer is preferably free of a hydrogen atom, and H in all of the C—H bonds can be fluorinated.

The fluorine-containing ethylene-based monomer may be, for example, chlorotrifluoroethylene represented by the following formula (2).

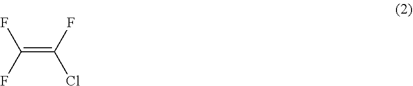

In a case where the optical resin composition of the present embodiment satisfies the matter (a), the refractive index modifier may include a linear polymer (for example, oligomer of chlorotrifluoroethylene in which the number of repeating units is 4, 6, 7, and/or the like) that includes repeating units based on a fluorine-containing ethylene-based monomer at the number of the repeating units (for example, the number of the repeating units is 4, 6, 7, and/or the like) other than that of the linear polymer (A), as long as the content of the linear polymer is 5 mass % or less. Furthermore, in a case where the optical resin composition of the present embodiment satisfies the matter (b), the refractive index modifier may include a linear polymer (for example, oligomer of chlorotrifluoroethylene in which the number of repeating units is 4, 5, 7, and/or the like) that includes repeating units based on a fluorine-containing ethylene-based monomer at the number of the repeating units (for example, the number of the repeating units is 4, 5, 7, and/or the like) other than that of the linear polymer (B), as long as the content of the linear polymer is 5 mass % or less.

As described above, the optical resin composition of the present embodiment is desirably free of a C—H bond. Therefore, preferably, a first linear polymer and a second linear polymer are substantially free of hydrogen atoms. More preferably, the first linear polymer and the second linear polymer are free of hydrogen atoms. In the description herein, that the first and the second linear polymers are substantially free of hydrogen atoms means that a proportion of a content of hydrogen atoms in the first and the second linear polymers is 1 mol % or less.

A glass transition temperature of the fluorine-containing resin included in the optical resin composition of the present embodiment is 105° C. or higher and preferably 120° C. or higher. In a case where the fluorine-containing resin has such a high glass transition temperature, influence of reduction of the glass transition temperature due to addition of the refractive index modifier, on the optical resin composition obtained by mixing the fluorine-containing resin and the refractive index modifier, is small, and the high glass transition temperature can be maintained. Therefore, in this case, the optical resin composition of the present embodiment can also have high thermal resistance. The upper limit of the glass transition temperature of the fluorine-containing resin included in the optical resin composition of the present embodiment is, but is not particularly limited to, for example, 140° C. or lower.

The fluorine-containing resin included in the optical resin composition of the present embodiment is, for example, a polymer for which a fluorine-containing compound having a polymerizable double bond is a monomer. The optical resin composition of the present embodiment is used for optical applications. The optical resin composition is desirably free of a C—H bond from the viewpoint of reducing light absorption due to stretching energy of a C—H bond. Therefore, preferably, the fluorine-containing resin is substantially free of a hydrogen atom, and H in all of C—H bonds is particularly preferably fluorinated. That is, preferably, the fluorine-containing resin is substantially free of a hydrogen atom, and is fully fluorinated. That the fluorine-containing resin is substantially free of a hydrogen atom means that a proportion of a content of hydrogen atoms in the fluorine-containing resin is 0.1 mol % or less.

In a case where the fluorine-containing resin is a fully-fluorinated one, examples of the fluorine-containing compound of the monomer constituting the fluorine-containing resin include compounds represented by the following formula (3).

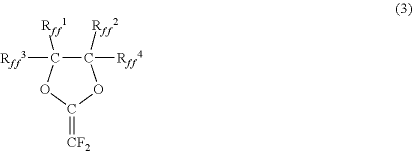

(in the formula (3), R_{ff}¹ to R_{ff}⁴ each independently represent a fluorine atom, a perfluoroalkyl group having 1 to 7 carbon atoms, or a perfluoroalkyl ether group having 1 to 7 carbon atoms. R_{ff}¹ and R² are optionally linked to form a ring.)

Specific examples of the compound represented by the formula (3) include compounds represented by the following formulas (A) to (H).

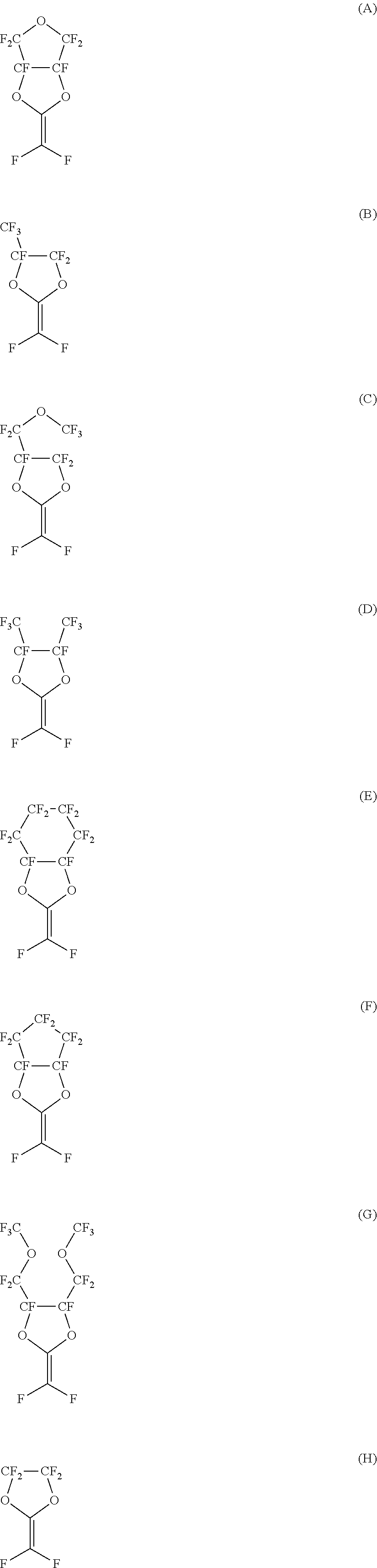

For the fluorine-containing compound of the monomer constituting the fluorine-containing resin, the compound (B), that is, the fluorine-containing compound represented by the following formula (4), is preferably used, among the compounds represented by the formulas (A) to (H).

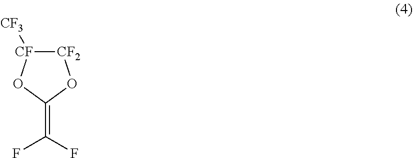

A polymer for which the compound represented by the formula (4) is a monomer can have a high glass transition temperature of, for example, about 110° C. or higher. Therefore, by using such a fluorine-containing resin, the optical resin composition obtained by mixing the fluorine-containing resin and the refractive index modifier can maintain a high glass transition temperature, and has excellent thermal resistance.

As the fluorine-containing compound, a product that has been purified so as to be free from impurities is preferably used. The purification can be performed by a known method. Among impurities, particularly, an acid component affects coloring and is thus preferably excluded.

The fluorine-containing compound used as the monomer may be formed of two or more kinds of compounds. That is, the fluorine-containing resin used for the optical resin composition of the present embodiment may be a copolymer of a plurality of kinds of fluorine-containing compounds. Examples of the fluorine-containing compound used as a monomer (comonomer) of the copolymer include tetrafluoroethylene, chlorotrifluoroethylene, and fluorovinylether (perfluoropropylvinyl ether and the like) in addition to the fluorine-containing compounds represented by the formulas (A) to (H).

The fluorine-containing resin used for the optical resin composition of the present embodiment can be produced by, for example, using the above-described fluorine-containing compound as the monomer, and polymerizing the monomers in a known method with use of, for example, a known polymerization initiator or the like. As the polymerization method, a known polymerization method can be used. For example, the fluorine-containing resin can be produced by radical polymerization of the above-described fluorine-containing compound in a conventional method. A fully-fluorinated fluorine-containing resin can be produced by using, as the monomer, a fully-fluorinated fluorine-containing compound that is the fluorine-containing compound to be used, and further using a polymerization initiator formed of a fully-fluorinated compound.

The optical resin composition of the present embodiment can have high transparency. For example, the optical resin composition of the present embodiment can achieve such transparency that internal transmittance is 99.9% or higher. The internal transmittance of the optical resin composition can be measured by, for example, the following method. The optical resin composition is sealed in a cylindrical container, and heated and melted, whereby the optical resin composition is formed into a cylindrical rod. The temperature for the heating and melting is determined as appropriate according to, for example, a melting temperature of the fluorine-containing resin included in the optical resin composition. For example, in a case where the fluorine-containing resin included in the optical resin composition is a fluorine-containing resin obtained by using the above-described fluorine-containing compound as the monomer and polymerizing the monomers, the optical resin composition is heated and melted at, for example, 270° C. Unevenness is eliminated by grinding the upper surface and the bottom surface of the obtained rod, and transmittance of the rod at a wavelength of 850 nm is thereafter measured by using, for example, a UV-Visible-Near Infrared spectrophotometer U-4100 manufactured by Hitachi High-Tech Science Corporation. Transmittances of two rods (rod 1 and rod 2) having different lengths are substituted into the following mathematical expression, to calculate internal transmittance.

log_{T}=−(log T1−log T2)×10/Δd
Internal transmittance: T
T1: transmittance (%) of the rod 1 at a wavelength of 850 nm as obtained by U-4100
T2: transmittance (%) of the rod 2 at a wavelength of 850 nm as obtained by U-4100
Δd: difference in length between the rod 1 and rod 2 (Δd>0)

In the optical resin composition of the present embodiment, for example, a refractive index with respect to light having a wavelength of 850 nm may be 1.310 or higher and 1.355 or lower.

The glass transition temperature of the optical resin composition of the present embodiment is preferably 100° C. or higher and more preferably 105° C. or higher. The optical resin composition of the present embodiment having such a glass transition temperature can have high thermal resistance. The upper limit of the glass transition temperature of the optical resin composition of the present embodiment may be, but is not particularly limited to, for example, 140° C. or lower.

### Embodiment 2

An embodiment of an optical resin formed body of the present invention will be described.

The optical resin formed body of the present embodiment includes the optical resin composition of Embodiment 1. As described in Embodiment 1, the optical resin composition of Embodiment 1 can have a high glass transition temperature, and, furthermore, can have the refractive index adjusted in a desired range. Therefore, the optical resin formed body of the present embodiment can be suitably used for optical transmitting bodies such as POFs and materials of optical waveguides, optical lenses, and prisms, and the like. The optical resin formed body of the present embodiment can be suitably applied to optical transmitting bodies, and can be particularly suitably applied to POFs.

In a case where the optical resin formed body of the present embodiment is a POF, the optical resin formed body of the present embodiment can be used as, for example, a core material of a graded-index POF in which refractive indexes of a core are distributed so as to be symmetric with respect to a central axis. The optical resin formed body of the present embodiment includes the optical resin composition in which the refractive index modifier is added to the fluorine-containing resin. Therefore, by diffusing the refractive index modifier in the optical resin formed body, a refractive index distribution can be easily formed.

The optical resin formed body of the present embodiment can be produced by, for example, a production method including a step of heating and melting the optical resin composition of Embodiment 1 at a temperature that is higher than the glass transition temperature of the optical resin composition by 50° C. or more, and forming the optical resin composition into a predetermined shape. The optical resin formed body having a refractive index distribution can be obtained also by thermal diffusion of the refractive index modifier in the optical resin composition during heating of the optical resin composition. As described in Embodiment 1, the optical resin composition used for the optical resin formed body of the present embodiment can be used even in high-temperature processing, and also has high transparency. Therefore, the optical resin formed body of the present embodiment can be a formed body having a refractive index adjusted in a desired range and having sufficient transparency.

A specific forming method is determined as appropriate according to the application. That is, a known forming method for each application can be used. For example, in a case where the optical resin formed body of the present embodiment is a POF, the formed body can be produced by, for example, spinning the optical resin composition into a fibrous form through melt-extrusion. When the spinning is performed through the melt-extrusion, the refractive index modifier is diffused in the optical resin composition by heating, whereby a core of a graded-index POF in which the refractive indexes of the core are distributed so as to be symmetric with respect to the central axis, can be produced.

### Examples

Hereinafter, the present invention will be described in more detail by way of examples. The present invention is not limited to the following examples.

(Preparation of fluorine-containing resin)

A polymer of perfluoro-4-methyl-2-methylene-1,3-dioxolane (compound represented by the above-described formula (4)) was prepared as the fluorine-containing resin. Perfluoro-4-methyl-2-methylene-1,3-dioxolane was synthesized by firstly synthesizing 2-carboxymethyl-2-trifluoromethyl-4-methyl-1,3-dioxolane, fluorinating the 2-carboxymethyl-2-trifluoromethyl-4-methyl-1,3-dioxolane, and decarbonating and separating the obtained carboxylate. For polymerization of perfluoro-4-methyl-2-methylene-1,3-dioxolane, perfluorobenzoyl peroxide was used as a polymerization initiator.

Synthesis of 2-carboxymethyl-2-trifluoromethyl-4-methyl-1,3-dioxolane, fluorination of 2-carboxymethyl-2-trifluoromethyl-4-methyl-1,3-dioxolane, synthesis of perfluoro-4-methyl-2-methylene-1,3-dioxolane, and polymerization of perfluoro-4-methyl-2-methylene-1,3-dioxolane will be described below in detail.

<Synthesis of 2-carboxymethyl-2-trifluoromethyl-4-methyl-1,3-dioxolane>

A 3 L three-necked flask having a water-cooling cooler, a thermometer, a magnetic stirrer, and an isobaric dropping funnel were prepared, and 139.4 g (1.4 mol in total) of a mixture of 2-chloro-1-propanol and 1-chloro-2-propanol was put in the flask. The flask was cooled to 0° C., methyl trifluoropyruvate was slowly added into the flask, and the obtained product was further stirred for two hours. To the obtained product, 100 mL of dimethyl sulfoxide (DMSO) and 194 g of potassium carbonate were added over one hour, and thereafter, the obtained product was further stirred continuously for eight hours, to obtain a reaction mixture. The produced reaction mixture was mixed with 1 L of water, the aqueous phase was separated and further subjected to extraction with dichloromethylene, the dichloromethylene solution was mixed with an organic reaction mixture phase, and the solution was dried with magnesium sulfate. After a solvent was removed, 245.5 g of a crude product was obtained. Fractional distillation of the crude product was performed under a reduced pressure (12 Torr), and 230.9 g of a purified product of 2-carboxymethyl-2-trifluoromethyl-4-methyl-1,3-dioxolane was obtained. The purified product had a boiling point of 77 to 78° C., and a yield thereof was 77%. It was confirmed by HNMR and ¹⁹FNMR that the obtained purified product was 2-carboxymethyl-2-trifluoromethyl-4-methyl-1,3-dioxolane.

HNMR (ppm): 4.2-4.6, 3.8-3.6 (CHCH₂, muliplet, 3H), 3.85-3.88 (COOCH₃, multiplet, 3H), 1.36-1.43 (CCH₃, multiplet, 3H)

¹⁹FNMR (ppm): −81.3 (CF₃, s, 3F)

<Fluorination of 2-carboxymethyl-2-trifluoromethyl-4-methyl-1,3-dioxolane>

Into a 10 L stirring reaction tank, 4 L of 1,1,2-trichlorotrifluoroethane was injected. Nitrogen was caused to flow in the stirring reaction tank at a flow rate of 1340 cc/min, and fluorine was caused to flow at a flow rate of 580 cc/min, to generate a nitrogen/fluorine atmosphere. After elapse of five minutes, 290 g of 2-carboxymethyl-2-trifluoromethyl-4-methyl-1,3-dioxolane having been previously prepared was dissolved in 750 mL of a 1,1,2-trichlorotrifluoroethane solution, and the solution was added into the reaction tank at a rate of 0.5 ml/minute. The reaction tank was cooled to 0° C. After the whole dioxolane was added over 24 hours, fluorine gas flow was stopped. Nitrogen gas was purged, and potassium hydroxide aqueous solution was thereafter added until a weak alkaline solution was obtained.

A volatile substance was removed under a reduced pressure, a portion around the reaction tank was thereafter cooled, and the obtained product was thereafter dried under a reduced pressure at 70° C. for 48 hours, whereby a solid reaction product was obtained. The solid reaction product was dissolved in 500 mL of water, and an excess amount of hydrochloric acid was added to separate the reaction product into an organic phase and an aqueous phase. The organic phase was separated and distilled under a reduced pressure, to obtain perfluoro-2,4-dimethyl-1,3-dioxolane-2-carboxylic acid. The main distilled product had a boiling point of 103° C. to 106° C./100 mmHg. The yield in the fluorination was 85%.

<Synthesis of perfluoro-4-methyl-2-methylene-1,3-dioxolane>

The above-described distilled product was neutralized with potassium hydroxide aqueous solution, to obtain perfluoro-2,4-dimethyl-2-potassium carboxylate-1,3-dioxolane. The potassium salt was vacuum-dried at 70° C. for one day. The salt was decomposed at 250° C. to 280° C. under a nitrogen or argon atmosphere. The obtained product was condensed in a cooling trap having been cooled to −78° C., to obtain perfluoro-4-methyl-2-methylene-1,3-dioxolane at a yield of 82%. The obtained product had a boiling point of 45° C./760 mmHg. The obtained product was identified by using ¹⁹FNMR and GC-MS.

¹⁹FNMR: −84 ppm (3F, CF₃), −129 ppm (2F, ═CF₂)

GC-MS: m/e244 (Molecular ion) 225, 197, 169, 150, 131, 100, 75, 50.

<Polymerization of perfluoro-4-methyl-2-methylene-1,3-dioxolane>

In a glass tube, 100 g of perfluoro-4-methyl-2-methylene-1,3-dioxolane obtained in the above-described method, and 1 g of perfluorobenzoyl peroxide was sealed. Oxygen in the system was removed by freeze-deaeration, and the glass tube was thereafter refilled with argon and was heated at 50° C. for several hours. The content became solid but was further heated overnight at 70° C., to obtain 100 g of a transparent rod-like product.

The obtained transparent rod-like product was dissolved in Fluorinert FC-75 (manufactured by Sumitomo 3M Limited), and the obtained solution was poured onto a glass plate, to obtain a thin film formed of a polymer. The obtained polymer had a glass transition temperature of 117° C., and was fully amorphous. The transparent rod-like product was dissolved in hexafluorobenzene, and chloroform was added to the obtained product to cause precipitation, thereby purifying the product. The purified polymer had a glass transition temperature of about 135° C.

(Refractive Index Modifier)

An oligomer for which chlorotrifluoroethylene was a monomer was used as the refractive index modifier. Specifically, DAIFLOIL #10 (manufactured by DAIKIN INDUSTRIES, LTD.) was prepared and distilled, to isolate the oligomer in units of the number of repeating units. In the Examples, oligomers in which the numbers of repeating units were 4, 5, 6, and 7 were each isolated. In the Examples, DAIFLOIL #10 (manufactured by DAIKIN INDUSTRIES, LTD.) was used as a polymer of the fluorine-containing ethylene-based monomers and distilled to isolate an oligomer having the fluorine-containing ethylene-based monomers at a predetermined number of repeating units. However, a polymer to be used is not limited thereto. Examples of a usable polymer include DAIFLOIL #20 (manufactured by DAIKIN INDUSTRIES, LTD.), Halocarbon 700 (manufactured by Genesee Scientific Corporation), Halocarbon 27 (manufactured by Genesee Scientific Corporation), DAIFLOIL #50 (manufactured by DAIKIN INDUSTRIES, LTD.), and DAIFLOIL #100 (manufactured by DAIKIN INDUSTRIES, LTD.).

(The number of repeating units of polymer of refractive index modifier)

By using a gas chromatograph time-of-flight mass spectrometer (GC/TOFMS), purity of the polymer in units of the number of repeating units was analyzed for each refractive index modifier. It was confirmed that the purity was 95 mol % or higher in each refractive index modifier.

(Optical Resin Composition)

The fluorine-containing resin and the refractive index modifier were melt-mixed at 250° C., and an optical resin composition of each of Examples 1 to 14 and Comparative examples 1 to 10 indicated in Table 1 was prepared. As the fluorine-containing resin, the polymer of perfluoro-4-methyl-2-methylene-1,3-dioxolane prepared in the above-described method was used. The refractive index modifiers used in the examples and the comparative examples are as indicated in Table 1.

(Proportion of content of refractive index modifier in optical resin composition)

A proportion of a content of each refractive index modifier in the optical resin composition was analyzed by using ion chromatography (IC). Table 1 indicates the results.

(Volatilization start temperature)

About 10 mg of each optical resin composition indicated in Table 1 was collected and subjected to thermogravimetric analysis (TGA). A Discovery TGA manufactured by TA Instruments was used as an analyzer. An atmosphere gas was N2 (25 ml/min). The container was made of platinum. The temperature range was from room temperature to 1000° C., and a temperature rise rate was 10° C./min. Based on the obtained temperature-weight curve, an extrapolated weight reduction start temperature (a point at which a baseline of 100% and a tangent to an inclined line of weight reduction intersected each other) was determined as the volatilization start temperature. Criteria of volatility are as follows. Table 1 indicates the results.
A: volatilization start temperature≥200° C.
B: 200° C.>volatilization start temperature>180° C.
C: volatilization start temperatures≤180° C.

(Transparency)

Whether the optical resin composition was colorless and transparent, or clouded was visually determined. Criteria of transparency are as follows. Table 1 indicates the results.
A: transparent
B: partially clouded
C: clouded

(Thermal resistance of optical resin composition)

A glass transition temperature of each of the optical resin compositions indicated in Table 1 was measured. A condition in which the glass transition temperature (Tg) was measured was as follows. About 5 mg of the optical resin composition was collected and put in an aluminium container, and subjected to differential scanning calorimetry (DSC measurement). A Q-2000 manufactured by TA Instruments was used as the device. The temperature program was −80° C.→200° C.→80° C.→200° C., a measurement rate was 10° C./min, and an atmosphere gas was N2 (50 ml/min). Criteria of thermal resistance are as follows. Table 1 indicates the results.
A: Tg≥105° C.
B: 105° C.>Tg≥100° C.
C: Tg<100° C.

(Difference in refractive index of optical resin composition)

A refractive index of each of the optical resin compositions indicated in Table 1 was measured. About 500 mg of each of the optical resin compositions was weighed and taken, and heated and pressed at a temperature of 180 to 250° C. and a pressure of 20 MPa to form a film having a thickness of about 100 μm. A refractive index with respect to light having a wavelength of 848 nm was measured for the obtained film by a prism coupler. Similarly, a refractive index of the fluorine-containing resin alone in a state of containing no refractive index modifier was measured, and a difference therebetween was defined as refractive index difference. Criteria of the refractive index difference are as follows. Table 1 indicates the results.
A: refractive index difference≥0.0400
B: 0.0400>refractive index difference≥0.0225
C: refractive index difference<0.0225

TABLE 1

| | | Optical resin composition | | | | | |
|---|---|---|---|---|---|---|---|
| | | | Proportion (mass %) | | | | |
| | | The number of repeating | of content of linear | | | | |
| | | units of linear polymer | polymer used as | | Refractive | | Volatilization |
| | | used as refractive index | refractive index | | index | Thermal | start |
| | | modifier | modifier | Transparency | difference | resistance | temperature |
| Example | 1 | 6 | 7 | A | C | A | A |
| | 2 | 6 | 8 | A | B | A | A |
| | 3 | 6 | 9 | A | B | A | A |
| | 4 | 6 | 10 | A | A | A | A |
| | 5 | 6 | 11 | A | A | A | A |
| | 6 | 6 | 12 | A | A | A | A |
| Comparative | 1 | 6 | 13 | C | A | A | A |
| example | | | | | | | |
| Example | 7 | 5 | 7 | A | C | A | A |
| | 8 | 5 | 8 | A | B | A | A |
| | 9 | 5 | 9 | A | A | A | A |
| | 10 | 5 | 10 | A | A | A | A |
| | 11 | 5 | 11 | A | A | A | A |
| | 12 | 5 | 12 | A | A | A | B |
| | 13 | 5 | 13 | A | A | B | B |
| | 14 | 5 | 14 | A | A | B | B |
| Comparative | 2 | 5 | 15 | A | A | C | C |
| example | | | | | | | |
| Comparative | 3 | 4 | 8 | A | C | A | C |
| example | 4 | 4 | 9 | A | B | A | C |
| | 5 | 4 | 10 | A | B | A | C |
| | 6 | 4 | 11 | A | A | A | C |
| | 7 | 4 | 12 | A | A | B | C |
| | 8 | 4 | 13 | A | A | C | C |
| Comparative | 9 | 7 | 8 | C | C | A | — |
| example | 10 | 7 | 9 | C | C | A | — |

As indicated in Table 1, according to the results of Examples 1 to 6 and Comparative example 1, in a case where the number of repeating units of the linear polymer used as the refractive index modifier was 6, that is, in a case where the linear polymer (B) was used as the refractive index modifier, when the proportion of the content of the linear polymer (B) in the optical resin composition was less than 13 mass %, all of transparency, thermal resistance, and the volatilization start temperature were good. Particularly, when the proportion of the content of the linear polymer (B) in the optical resin composition was 8 mass % or more and less than 13 mass %, the refractive index difference was large in addition to all of transparency, thermal resistance, and the volatilization start temperature being good. That is, in this case, it was also found that, in addition to transparency, thermal resistance, and the volatilization start temperature being excellent, the refractive index modifier more easily adjusted the refractive index in an appropriate range.

As indicated in Table 1, according to the results of Examples 7 to 14 and Comparative example 2, in a case where the number of repeating units of the linear polymer used as the refractive index modifier was 5, that is, in a case where the linear polymer (A) was used as the refractive index modifier, when the proportion of the content of the linear polymer (A) in the optical resin composition was less than 15 mass %, excellent transparency was able to be achieved, and, furthermore, the thermal resistance and the volatilization start temperature were also within ranges which did not hinder practical use. Particularly, when the proportion of the content of the linear polymer (A) in the optical resin composition was 8 mass % or more and 12 mass % or less, thermal resistance was more excellent, and the refractive index difference became larger. That is, in this case, it was also found that excellent transparency and thermal resistance were obtained, and, furthermore, the refractive index modifier more easily adjusted the refractive index in an appropriate range. When the proportion of the content of the linear polymer (A) in the optical resin composition was 8 mass % or more and 11 mass % or less, the volatilization start temperature was good, and all of transparency, thermal resistance, the refractive index difference, and the volatilization start temperature were excellent.

In a case where the number of repeating units of the linear polymer used as the refractive index modifier was 4, even when the proportion of the content of the linear polymer in the optical resin composition was 8 parts by mass and low, the volatilization start temperature was low.

In a case where the number of repeating units of the linear polymer used as the refractive index modifier was 7, even when the proportion of the content of the linear polymer in the optical resin composition was 8 parts by mass and low, transparency was low and the optical resin composition was found to be clouded.

It was confirmed from the temperature-weight curve obtained by TGA that volatilization did not fully occur even at a temperature higher than 250° C., in the optical resin composition, as indicated in the examples in Table 1, in which the volatilization start temperature was 200° C. or higher. Therefore, the optical resin composition in the examples allows the refractive index to be adjusted in a desired range even when used in processing in which the temperature is, for example, about 250° C., and is determined to be sufficiently usable.

According to the above-described results, it has been confirmed that the optical resin composition of the present invention can be used even in high-temperature processing, and allows degradation of transparency to be inhibited.

### INDUSTRIAL APPLICABILITY

The optical resin composition of the present invention can be used as, for example, a material of an optical component that is required to have high transparency and is produced by high-temperature processing, and is particularly suitably used as a material of a core of a POF.

1. An optical resin composition comprising:
fluorine-containing resin; and
a refractive index modifier, wherein
the optical resin composition satisfies the following matter (a) or (b),
(a) the refractive index modifier includes 95 mass % or more of a linear polymer (A) including repeating units based on a fluorine-containing ethylene-based monomer such that the number of the repeating units is 5, and a proportion of a content of the linear polymer (A) in the optical resin composition is 1 mass % or more and less than 15 mass %,
(b) the refractive index modifier includes 95 mass % or more of a linear polymer (B) including repeating units based on a fluorine-containing ethylene-based monomer such that the number of the repeating units is 6, and a proportion of a content of the linear polymer (B) in the optical resin composition is 1 mass % or more and less than 13 mass %.

2. The optical resin composition according to claim 1, wherein the fluorine-containing ethylene-based monomer is represented by the following formula (1). 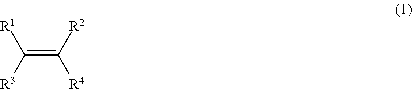
(in the formula (1), R¹ represents a fluorine atom, and R², R³, and R⁴ each independently represent a fluorine atom, a halogen atom, or a hydrogen atom.)

3. The optical resin composition according to claim 2, wherein the fluorine-containing ethylene-based monomer is free of a hydrogen atom.

4. The optical resin composition according to claim 2, wherein the fluorine-containing ethylene-based monomer is represented by the following formula (2).

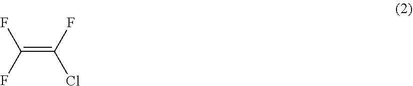

5. The optical resin composition according to claim 1, wherein a glass transition temperature of the fluorine-containing resin is 105° C. or higher and 140° C. or lower.

6. The optical resin composition according to m claim 1, wherein the fluorine-containing resin is substantially free of a hydrogen atom and is fully fluorinated.

7. The optical resin composition according to claim 6, wherein the fluorine-containing resin is a polymer of a fluorine-containing compound represented by the following formula (3). 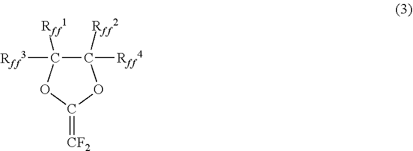
(in the formula (3), R_{ff}¹ to R_{ff}⁴ each independently represent a fluorine atom, a perfluoroalkyl group having 1 to 7 carbon atoms, or a perfluoroalkyl ether group having 1 to 7 carbon atoms. R_{ff}¹ and R_{ff}² are optionally linked to form a ring.)

8. The optical resin composition according to claim 7, wherein the fluorine-containing compound is a polymer of a fluorine-containing compound represented by the following formula (4).

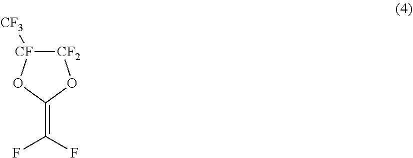

9. The optical resin composition according to claim 1, wherein a glass transition temperature of the optical resin composition is 105° C. or higher and 140° C. or lower.

10. An optical resin formed body comprising the optical resin composition according to claim 1.

11. The optical resin formed body according to claim 10, wherein the optical resin formed body is an optical transmitting body.

12. The optical resin formed body according to claim 11, wherein the optical transmitting body is a plastic optical fiber.
